(19) United States
(12) Patent Application Publication
(10) Pub. No.: US 2025/0050311 A1
(43) Pub. Date: Feb. 13, 2025

(54) METHOD AND APPARATUS FOR CARBON DIOXIDE SEPARATION

(71) Applicant: MOF TECHNOLOGIES LIMITED, Belfast (GB)

(72) Inventors: Jose CASABAN-JULIAN, Belfast (GB); Conor Hamill, Belfast (GB); Ciaran Coney, Belfast (GB); Tommaso Pellegrinelli, Beflast (GB); Matthew West, Belfast (GB)

(21) Appl. No.: 18/928,640

(22) Filed: Oct. 28, 2024

Related U.S. Application Data
(63) Continuation-in-part of application No. PCT/GB2023/051069, filed on Apr. 24, 2023.

(30) Foreign Application Priority Data
Apr. 27, 2022 (GB) 2206101.4
Nov. 1, 2023 (GB) 2316731.5

(51) Int. Cl. B01J 20/22; B01D 53/04; B01J 20/28; B01J 20/34

(52) U.S. Cl. CPC B01J 20/226; B01D 53/0446; B01J 20/28011; B01J 20/3425; B01D 2253/204; B01D 2257/504; B01D 2257/80; B01D 2259/402

(57) ABSTRACT

A method for removing CO₂ and H₂O from an exhaust gas, the method comprising: (a) an adsorption step in which a non-amine metal organic framework is contacted for 10-900 seconds with an exhaust gas comprising CO₂ in an amount of at least 3 v/v %, and H₂O in an amount of at least 0.3 v/v %, in order to adsorb CO₂ and H₂O onto the metal organic framework, and (b) a desorption step in which a vacuum is applied to the metal organic framework from step (a) such that CO₂ and H₂O are desorbed from the metal organic framework.

### RELATED APPLICATIONS

This application is a continuation-in-part of PCT/GB2023/051069 application, filed Apr. 24, 2023, which claims priority from Great Britain Patent Application No. 2206101.4, filed Apr. 27, 2022, and Great Britain Patent Application No. 2316731.5 filed Nov. 1, 2023, the entire disclosures of which are incorporated herein by reference.

This invention relates to a method and apparatus for removing CO₂ and H₂O from a gas.

### BACKGROUND

Metal-organic frameworks, hereafter referred to as “MOFs”, are crystalline or non-crystalline, porous metal-organic compounds which have particular pore sizes or pore distributions and large specific surface areas.

MOFs are known for use in gas adsorption processes. Such processes generally involve the separation of one or more components from a multicomponent gas stream in order to generate a purified gas.

Certain MOFs, particularly those with coordinatively unsaturated metal sites such as the MOF-74/CPO family, have demonstrated extremely high CO₂ uptake performance based on pure gas isotherms under equilibrium conditions. However, these MOFs have been found to be unstable under humid conditions. This problem has been considered an irremediable hindrance for their practical use in the purification of gas streams. This is because, in practice, gas mixtures from which CO₂ is to be removed often also contain water (H₂O).

In particular, the weak stability of MOF-74 analogues when contacted by humid gas streams has been widely reported in the literature. The decomposition of the MOF-74 family on contact with moist air or water even at room temperature has been described in detail. This very water-sensitivity has been attributed to material degradation and irreversible decomposition upon water exposure (even at ambient temperature) due to structural changes which ultimately lead to structural collapse.

Accordingly, MOF-74 analogues have not hitherto been considered suitable for most industrial applications of CO₂ removal from gas streams with a relatively high water content. The presence of water vapour has been deemed to reduce the gas adsorption capacity (including of CO₂) of these MOFs through the destruction of their structure.

Industrial applications produce various types of exhaust gases, which includes gases described as ‘flue gas’ or ‘stack gas’. Some exhaust gases are emitted as a result of the combustion of fuels such as natural gas, gasoline (petrol), diesel fuel, fuel oil, biodiesel blends, or coal. According to the type of ignition, burner or engine, etc., such gases can be discharged into the atmosphere through an exhaust pipe, flue gas stack, or propelling nozzle. Collins dictionary defines a “flue gas” as a waste gas from a combustion process.

Some exhaust gases are an end product of manufacturing processes such as cement, steel and lime manufacture.

An exhaust gas typically comprises the reaction products of at least a fuel and combustion air, and contains residual substances, such as particulate matter (dust), sulfur oxides, nitrogen oxides, and carbon monoxide, and, typically, a relatively high content of water. As mentioned above, the decomposition of the MOF-74 family on contact with moist air or water means that hitherto, the use of MOFs to help carbon capture of flue gases has been considered impractical.

Several academic articles have analysed the potential mechanism for destruction of MOF-74 materials by water. This has been mainly ascribed to the coordination bonds of MOF-74 compounds, which can be easily attacked by water.

Coordinatively unsaturated structures in MOF materials are able to dissociate water molecules. After water dissociation, the open metal site is thought to be occupied by dissociation products which hinder the adsorption of further molecules, such as CO₂.

Overall, MOF-74 (and similar types of material) have been considered to lack cyclic stability under real operational conditions. Their use has therefore been relegated only to industrial applications where the materials can be protected from moisture (for example where dehydration processes are considered necessary). Their instability under humid conditions has been considered a severe restriction for practical use in CO₂ removal processes. Journal articles where this has been discussed are listed below:
Understanding Structure, Metal Distribution, and Water Adsorption in Mixed-Metal MOF-74, Howe et al, J. Phys. Chem. C, 2017, 121, 1, 627-635.
Effects of polydimethylsiloxane coating of Ni-MOF-74 on CH₄ storage, Lee et al, Korean J. Chem. Eng., 35(3), 1-7 (2018).
Adsorption breakthrough and cycling stability of carbon dioxide separation from CO₂/N₂/H₂O mixture under ambient conditions using 13X and Mg-MOF-74, Qasem et al, Applied Energy 230 (2018) 1093-1107.
Thermodynamics Drives the Stability of the MOF-74 Family in Water, Voskanyan et al, ACS Omega 2020, 5, 13158-13163.
Water stable SiO₂-coated Fe-MOF-74 for aqueous dimethyl phthalate degradation in PS activated medium, Ding et al, Journal of Hazardous Materials 411 (2021) 125194.
Enhancing the Water Resistance of Mn-MOF-74 by Modification in Low Temperature NH₃—SCR, Wang et al, Catalysts 2019, 9, 1004.
Carbon Dioxide Removal from Flue Gas Using Microporous Metal Organic Frameworks, Lesch, David A., United States: N. p., 2010. Web. doi:10.2172/1003992.
Understanding and controlling water stability of MOF-74, Zuluaga et al, J. Mater. Chem. A, 2016, 4, 5176.

Improved methods for absorbing CO₂ from water-containing gas mixtures have therefore been sought.

U.S. Pat. No. 5,071,449A describes general pressure swing adsorption technologies. U.S. Ser. No. 10/239,012B2, EP2164607B1 and U.S. Pat. No. 9,144,770B2 relate to pressure swing adsorption processes with various adsorbents. U.S. Pat. No. 9,295,939B2 and U.S. Ser. No. 10/682,603B2 describe CO₂ removal processes which have a separate water removal step prior to CO₂ adsorption. Pressure swing adsorption processes with various types of MOF are described in U.S. Pat. No. 8,142,745B2 and EP2089137B1. US20140061540A1 relates to pressure swing adsorption processes that utilise MOF-74 materials, but in the absence of water and clearly stated that the stability of the materials need to be further studied.

### STATEMENT OF INVENTION

In a first aspect, this invention relates to a method for removing CO₂ and H₂O from an exhaust gas, the method comprising:
(a) an adsorption step in which a non-amine metal organic framework is contacted for 10-900 seconds with an exhaust gas comprising CO₂ in an amount of at least 3 v/v %, and H₂O in an amount of at least 0.3 v/v %, in order to adsorb CO₂ and H₂O onto the metal organic framework, and
(b) a desorption step in which a vacuum is applied to the metal organic framework from step (a) such that CO₂ and H₂O are desorbed from the metal organic framework.

It has been surprisingly found by the inventors that limiting the contact time during the adsorption step between the exhaust gas comprising CO₂ and relatively high H₂O, and the metal organic framework, significantly reduces degradation of the metal organic framework, by controlling the amount and exposure time of moisture to the metal organic framework. Consequently, this allows consistent performance of the metal organic framework under humid gas streams for extended periods of time. In particular, the metal organic framework may form a covalent, hydrogen, ionic or other bond with the CO₂ and H₂O. More particularly, the method of the invention may be defined as a pressure swing adsorption method.

In particular, in step (a) the metal organic framework may be contacted for (or is in the range of) 10-300 seconds with the exhaust gas, optionally for 15-200 seconds, more optionally for 20-60 seconds, and including ranges based on 10, 15, 20, 30, 40, 50, 60, 70, 80, 90, 100, 120, 150, 180, 200, 240, 270 and 300 seconds.

In particular, in step (b), the vacuum is applied to the metal organic framework for (or is in the range of) 10-300 seconds, optionally for 15-200 seconds, more optionally for 20-60 seconds, including ranges based on 10, 15, 20, 30, 40, 50, 60, 70, 80, 90, 100, 120, 150, 180, 200, 240, 270 and 300 seconds.

Metal organic frameworks (MOFs) are generally defined as crystalline or non-crystalline, porous metal-organic compounds, having particular pores or pore distributions and large specific surface areas. Metal organic frameworks have been given various names in the literature, including coordination polymers, metal-organic coordination networks (MOCNs) and porous coordination polymers (PCPs). MOFs generally comprise metal cations and organic bridging groups (or ligands). In MOFs, the organic groups bridge between metal ions so that a polymeric structure results. This polymeric network may extend in one, two or three dimensions. Of particular interest are those structures which extended in two or three dimensions because they may be porous. Specifically, the structures may contain pores which can accommodate other molecules. Given that the pores can have specific sizes, shapes and chemical functionalities, such materials can show selectivity for the absorption of particular guest molecules. This invention extends to the use of coordinatively unsaturated metal sites with or without a Lewis Acid or base group (e.g. amino functionality), for the effective adsorption of CO₂ molecules from humid gas streams.

The term non-amine metal organic framework as used herein relates to the metal organic framework not including directly or on a ligand an amine group or moiety, including any cyclic amines, and including any diamines and triamines. Amine groups on metal organic frameworks are susceptible to detachment from the remainder of the non-amine metal organic framework when undergoing extensive temperature and/or pressure swing changes, leading to stability, performance and degradation concerns over a significant number of cycles. Non-amine metal organic frameworks are also cheaper and easier to manufacture.

The metal organic framework can comprise coordinatively unsaturated sites. Coordinatively unsaturated sites, which are also known as open metal sites, refer to metal ions which are not fully coordinated, and are formed once the metal organic framework is ‘activated’ in a known manner. Open metal site chemistry has been demonstrated for a wide variety of MOFs including HKUST-1 and MOF-74. In particular, the metal organic framework may comprise one or more reactive side groups. More particularly, the one or more reactive side groups may comprise a Lewis acid group or a Lewis base group.

In classical coordination chemistry or organometallic chemistry, the concept of free coordination (i.e. coordinatively unsaturated) sites is well-known. A free coordination site exists in complexes where there is a lower than normal coordination number for the metal atom. This is dictated by coordination chemistry principles, such as the metal atom size and d-electron configuration. For example, for those 3d metal atoms for which an octahedron with coordination number six would be expected, a missing ligand and only fivefold coordination would establish a free coordination site.

For example, desolvation of MOF-74 can convert the metal centres of the framework from an octahedral coordination geometry with one bound solvent molecule to a square pyramidal geometry with an open coordination site. Square-planar metal complexes, which are often found for d8 metal atoms, inherently have two free coordination sites. In MOFs, the metal ion utilised for the generation of the open metal sites can be part of the metal node, metal secondary building unit or part of a linker.

In particular, the metal organic framework may comprise one or more of the following metal cations: Mg²⁺, Ca2+, Sr²⁺, Ba²⁺, Sc³⁺, Y³⁺, Ti⁴⁺, Zr⁴⁺, Hf⁴⁺, V⁴⁺, V³⁺, V²⁺, Nb³⁺, Ta³⁺, Cr³⁺, Mo³⁺, W³⁺, Mn³⁺, Mn²⁺, Re³⁺, Re²⁺, Fe³⁺, Fe²⁺, Ru³⁺, Ru²⁺, OS³⁺, OS²⁺, Co³⁺, CO²⁺, Rh²⁺, Rh⁺, Ir²⁺, Ir⁺, Ni²⁺, Ni⁺, Pd²⁺, Pd⁺, Pt²⁺, Pt⁺, Cu²⁺, Cu⁺, Ag⁺, Au⁺, Zn²⁺, Cd²⁺, Hg²⁺, Al³⁺, Ga³⁺, In³⁺, Ti³⁺, Si⁴⁺, Si²⁺, Ge⁴⁺, Ge²⁺, Sn⁴⁺, Sn²⁺, Pb⁴⁺, Pb²⁺, As⁵⁺, As³⁺, As⁺, Sb⁵⁺, Sb³⁺, Sb⁺, Bi⁵⁺, Bi³⁺ and Bi⁺.

In particular, the metal organic framework may comprise metal cations with a valency of 2 or more. More particularly, the metal cations may comprise Mg²⁺, Ca2+, Mn²⁺, Fe²⁺, CO²⁺, Cu²⁺, Ni²⁺ or Zn²⁺. Even more particularly, the metal cations may comprise Cu²⁺, Ni²⁺ or Zn²⁺.

The second main component of the MOF (i.e. other than the metal cations) are the organic groups that bind to the metal ions through one or more atoms. These organic groups, or ligands, may bind through more than one atom to the same metal. In such cases the ligands are known as chelates. If binding through two atoms they are termed bidentate chelates. If binding through three atoms they are termed tridentate chelates, etc. Any combination of the above types of binding groups may occur within a chelate ligand. The term “at least bidentate organic compound” as used within the scope of the present invention refers to an organic compound comprising at least one functional group which is able to form at least two, preferably two, coordinative bonds to a given metal ion and/or to form one coordinative bond each to two or more, preferably two metal atoms.

More particularly, the metal organic framework may comprise an organic ligand.

In particular, the organic ligand may be a dicarboxylic acid, tricarboxylic acid or tetracarboxylic acid. It will be understood by the skilled person that these ligands will be present in the metal organic framework as the corresponding carboxylate anion. Thus, references in this patent application to carboxylic acid or similar are understood to refer to the corresponding carboxylate anion when part of the metal organic framework. More particularly, the organic ligand may be a dicarboxylic acid. Even more particularly, the dicarboxylic acid may be 1,4-butanedicarboxylic acid, tartaric acid, glutaric acid, oxalic acid, 4-oxo-pyran-2, 6-dicarboxylic acid, 1,6-hexanedicarboxylic acid, decane dicarboxylic acid, 1,8-heptadecane dicarboxylic acid, 1,9-heptadecanedicarboxylic acid, heptadecanedicarboxylic acid, acetylene dicarboxylic acid, 1,2-benzenedicarboxylic acid, 2,3-pyridinedicarboxylic acid, 2,3-pyridine-dicarboxylic acid, 1,3-butadiene-1,4-dicarboxylic acid, 1,4-benzenedicarboxylic acid, 1,3-benzenedicarboxylic acid, imidazole-2,4-dicarboxylic acid, 2-methyl-quinoline-3,4-dicarboxylic acid, quinoline-2,4-dicarboxylic acid, quinoxaline-2,3-dicarboxylic acid, 6-chloroquinoxaline-2,3-dicarboxylic acid, 4,4I-diaminphenylmethan-3,3′-dicarboxylic acid, quinoline-3,4-dicarboxylic acid, 7-chloro-4-hydroxyquinoline-2,8-dicarboxylic acid, diimiddicarboxylic acid, pyridine-2,6-dicarboxylic acid, 2-methylimidazole-4,5-dicarboxylic acid, thiophene-3,4-dicarboxylic acid, 2-isopropyl-4,5-dicarboxylic acid, tetrahydropyrane-4,4-dicarboxylic acid, perylene-3,9-dicarboxylic acid, perylenedicarboxylic, pluriol E 200-dicarboxylic acid, 3,6-dioxaoctanedicarboxylic acid, 3,5-cyclohexadiene-1,2-dicarboxylic acid, octanecarboxylic acid, pentane-3,3-carboxylic acid, 4,4′-diamino-1,1′-diphenyl-3,3′-dicarboxylic acid, 4,4′-diaminodiphenyl-3,3′-dicarboxylic acid, benzidine-3,3′-dicarboxylic acid, 1,4-bis-(phenylamino)-benzene-2,5-dicarboxylic acid, 1-1′dinaphthyl-8,8′-dicarboxylic acid, 7-chloro-8-methylquinoline-2,3-dicarboxylic acid, 1-anilinoanthraquinone-2,4′-dicarboxylic acid, polytetrahydrofuran-250-dicarboxylic acid, 1,4-bis-(carboxymethyl)-piperazin-2,3-dicarboxylic acid, 7-chloroquinoline-3, 8-dicarboxylic acid, 1-(4-carboxy)-phenyl-3-(4-chloro)-phenyl-pyrazolin-4 ,5-dicarboxylic acid, 1,4, 5,6,7,7-hexachloro-5-norbornene-2,3-dicarboxylic acid, phenylindanedicarboxylic acid, 1,3-dibenzyl-2-oxo-imidazolidine-4,5-dicarboxylic acid, 1,4-cyclohexanedicarboxylic acid, naphthalene-1,8-dicarboxylic acid, 2-Benzoylbenzol-1,3-dicarboxylic acid, 1,3-dibenzyl-2-oxo-imidazolidine-4,5-cis-dicarboxylic acid, 2,2′-biquinoline-4,4′-di-carboxylic acid, pyridine-3,4-dicarboxylic acid, 3,6,9-trioxaundecanedicarboxylic acid, O-hydroxybenzophenone-dicarboxylic acid, Pluriol E 300-dicarboxylic acid, Pluriol E 400-dicarboxylic acid, Pluriol E 600-dicarboxylic acid, pyrazole-3,4-dicarboxylic acid, 2,3-pyrazinedicarboxylic acid, 5,6-dimethyl-2,3-pyrazine dicarboxylic acid, 4,4′-diaminodiphenyl ether-diimidedicarboxylic acid, 4,4′-diaminodiphenylmethanediimidedicarboxylic acid, 4,4′-diamino-diphenylsulfone diimidedicarboxylic acid, 2,6-naphthalene dicarboxylic acid, 1,3-adamantanedicarboxylic, 1,8-naphthalenedicarboxylic acid, 2,3-naphthalenedicarboxylic acid, 8-Methoxy-2, 3-boxylic acid, 8-nitro-2, 3-naphthoic acid, 8-sulfo-2,3naphthalindicarboxylic acid, anthracene-2,3-dicarboxylic acid, 2′,3′-diphenyl-p-terphenyl4,4′-dicarboxylic acid, diphenyl-4,4′-dicarboxylic acid, imidazole-4,5-dicarboxylic acid, 4 (1 H)-oxo-thiochromen-2, 8-dicarboxylic acid, 5-tert-butyl-1,3-benzenedicarboxylic acid, 7,8-quinolinedicarboxylic acid, 4,5-imidazoledicarboxylic acid, 4-cyclohexene-1,2-dicarboxylic acid, hexatriacontandicarboxylic acid, tetradecanedicarboxylic acid, 1,7-heptanedicarboxylic acid, 5-hydroxy-1,3-benzenedicarboxylic acid, pyrazine-2,3-dicarboxylic acid, furan-2,5-dicarboxylic acid, 1-nonene-6,9-dicarboxylic acid, eicosenedicarboxylic acid, 4,4′-dihydroxydiphenylmethane-3,3′-dicarboxylic acid, 1-amino-4-methyl-9,10-dioxo-9,10-dihydroanthracene-2,3-dicarboxylic acid, 2,5-pyridinedicarboxylic acid, cyclohexene-2,3-dicarboxylic acid, 2,9-Dichlorfluorubin-4, 11-dicarboxylic acid, 7-chloro-3-methylquinoline-6,8-dicarboxylic acid, 2,4-dichlorobenzophenone-2′5′-dicarboxylic acid, 1,3-benzenedicarboxylic acid, 2,6-pyridinedicarboxylic acid, 1-methylpyrrole-3,4-dicarboxylic acid, 1-benzyl-1H-pyrrole-3,4-dicarboxylic acid, anthraquinone-1,5-dicarboxylic acid, 3,5-pyrazoledicarboxylic acid, 2-nitrobenzene-1,4-dicarboxylic acid, heptane-1,7-dicarboxylic acid, cyclobutane-1,1-dicarboxylic acid, 1,14-tetradecane,5,6-dehydronorbornan-2,3-dicarboxylic acid or 5-ethyl-2,3-pyridinedicarboxylic acid.

In particular, the organic ligand may be a tricarboxylic acid. More particularly, the tricarboxylic acid may be 2-hydroxy-1,2,3-propanetricarboxylic acid, 7-chloro-2,3,8-quinolinetritri carboxylic acid, 1,2,4-benzenetricarboxylic acid, 1,2,4-butanetricarboxylic acid, 2-phosphono-1,2,4-butanetricarboxylic acid, 1,3,5-benzenetricarboxylic acid, 1-hydroxy-1,2,3-propane,4,5-dihydro-4,5-dioxo-1H-pyrrolo[2,3-F]quinoline-2,7,9-tricarboxylic acid, 5-acetyl-3-amino-6-methylbenzene-1,2,4-tricarboxylic acid, 3-amino-5-benzoyl-6-methylbenzene-1,2,4-tricarboxylic acid, 1,2,3-propanetricarboxylic acid or aurinetricarboxylic acid.

In particular, the organic ligand may be a tetracarboxylic acid. More particularly, the tetracarboxylic acid may be 1,1-dioxide-perylo[1,12-BCD]thiophene-3,4,9,10-tetracarboxylic acid, perylenetetracarboxylic acids such as perylene3,4,9,10-tetracarboxylic acid or perylene-1,12-sulfone-3,4,9,10-tetracarboxylic acid, butanetetracarboxylic acids such as 1,2,3,4-butanetetracarboxylic acid or meso-1,2,3,4-butanetetracarboxylic acid, decane-2,4,6,8-tetracarboxylic acid, 1,4,7,10,13,16-hexaoxacyclooctadecane-2,3,11,12-tetracarboxylic acid, 1,2,4,5-benzenetetracarboxylic acid, 1,2,11,12-dodecanetetracarboxylic acid, 1,2,5,6-hexanetetracarboxylic acid, 1,2,7,8-octanetetracarboxylic acid, 1,4,5,8-naphthalenetetracarboxylic acid, 1,2,9,10-decanetetracarboxylic acid, benzophenonetetracarboxylic acid, 3,3′,4,4′-benzophenonetetracarboxylic acid, tetrahydrofilrantetracarboxylic acid or cyclopentanetetracarboxylic acids such as cyclopentane-1,2,3,4-tetracarboxylic acid.

In particular, the organic ligand may be an at least monosubstituted mono-, di-, tri-, tetra- or polynuclear aromatic di, tri- or tetracarboxylic acid. Each of the nuclei may comprise at least one heteroatom, where two or more nuclei may comprise identical or different heteroatoms. More particularly, the organic ligand may be a mononuclear dicarboxylic acid, mononuclear tricarboxylic acid, mononuclear tetracarboxylic acid, dinuclear dicarboxylic acid, dinuclear tricarboxylic acid, dinuclear tetracarboxylic acid, trinuclear dicarboxylic acid, trinuclear tricarboxylic acid, trinuclear tetracarboxylic acid, tetranuclear dicarboxylic acid, tetranuclear tricarboxylic acid and/or tetranuclear tetracarboxylic acid. Examples of suitable heteroatoms include N, O, S, B, P, Si, Al, more particularly N, S and/or O. Suitable substituents to be mentioned in this respect are, inter alia, —OH, a nitro group, an amino group or an alkyl or alkoxy group.

More particularly, the organic ligand may comprise one or more functional groups. A wide variety of functional groups may be present on the organic ligands which do not bind to the metal ion but which impart various properties such as desirable solubilities, optical properties, electronic properties etc., or which affect the characteristics of the chemical bond between the metal and the organic group. In particular, the functional group may be an electron donating group or an electron withdrawing groups. More particularly, the functional group may comprise substituents which impart desirable steric properties. In particular, the organic ligands may be chiral.

In particular, the organic ligands may comprise a coordinating group which forms a coordinative bond with the metal ion. More particularly, the coordinating group may be —OH, —CO₂H, —SO₃H, —Si(OH)₃, —PO₃H, —CN, —NH₂, —NHR or —NR₂. In particular, the organic ligand may comprise two or more coordinating groups. More particularly, the coordinating groups may be attached to an organic group, R. More particularly, R may comprise an alkylene group having 1, 2, 3, 4 or 5 carbon atoms. Even more particular, R may comprise a methylene, ethylene, n-propylene, i-propylene, n-butylene, i-butylene, t-butylene or n-pentylene group or an aryl group containing one or two aromatic groups. In particular, the two aromatic groups may comprise two C6 rings which may or may not be condensed. More particularly, the one or two aromatic groups may, independently of one another, may substituted by at least one substituent each, and/or may, independently of one another, each comprise at least one heteroatom such as N, O and/or S. The coordinating groups can in principle be bound to any suitable organic compound, as long as the organic compound having these functional groups is capable of forming the coordinative bond and of producing the MOF material.

More particularly, the organic ligand may be one of the following, or an analogue where the aromatic ring is substituted by at least one heteroatom such as N, O and/or S.

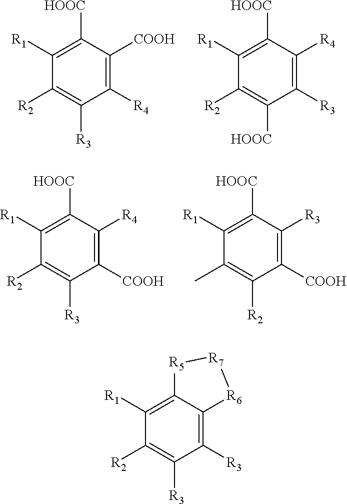

wherein R₁, R₂, R₃, R₄, R₅, R₆ and R₇ are individually selected from the group consisting of H, C, N, S, O, NH, CN, OH, ═O, ═S, SH, P. Br, CL, I, F, NH₂, —COOH, —COCH₃, —COOCH₃, —CONH₂, —COOCO, —CHO, —C═C, and —C═CH.

More particularly, the organic ligand may be an at least bidentate organic compound. In particular, the at least bidentate organic compound may comprise a benzenedicarboxylate ligand, a benzenetricarboxylate ligand, a benzenetetracarboxylate ligand or a dihydroxyterephthalate ligand, more particularly a benzene dicarboxylate ligand or a benzene tricarboxylate ligand. In particular, the at least bidentate organic compound may comprise 2,5 dihydroxyterephthalate, para-2,5-dioxido-1,4-benzenedicarboxylate or 6-dioxido-1,3-benzene-dicarboxylate. More particularly, the at least bidentate organic compound may comprise 2,5-dioxido-1,4-benzenedicarboxylate or 1,3,5-benzenetricarboxylate.

In particular, the metal organic framework may comprise a MOF-74, CPO-27, CPO-26, HKUST1 or MOF-505. More particularly, the metal organic framework may comprise a MOF-74. This is a specific example of a metal organic framework having comprise coordinatively unsaturated metal sites. Such sites are known to be reactive as Lewis acids, and have been found by the inventors to have efficacy as adsorption sites in MOF-74. In particular, the MOF-74 may comprise one or more metal atoms. More particularly, the metal atom may be one of more of Mn, Co, Ni or Zn. In particular, the MOF-74 may be one or more of Mn-MOF-74, Co-MOF-74, Ni-MOF-74, Zn-MOF-74, MnCo-MOF-74, MnNi-MOF-74, MnZn-MOF-74, Ni—Mg-MOF-74, and CoNi-MOF-74. More particularly, the metal organic framework may comprise a mixture of MOF-74 materials or mixed-metal compositions. The amount of each metal in the metal organic framework may be in variable proportions between 1-100 wt % of the total amount of metal.

In particular, step (a) of the method may be carried out at a temperature of 5-100° C. More particularly, step (a) may be carried out at a temperature of 30-60° C. In particular, step (b) of the method may be carried out at a temperature of 5-100° C. More particularly, step (b) may be carried out at a temperature of 30-60° C. In particular, steps (a) and (b) of the method may be carried out at a temperature of 5-100° C. More particularly, steps (a) and (b) may be carried out at a temperature of 30-60° C.

The exhaust gas may be derived from an industrial application producing an exhaust gases, which includes gases describe as ‘flue gas’ or ‘stack gas’. Some exhaust gases are emitted as a result of the combustion of fuels such as natural gas, gasoline (petrol), diesel fuel, fuel oil, biodiesel blends, or coal. Some exhaust gases are an end product of manufacturing processes such as cement, steel and lime manufacture.

An exhaust gas typically comprises the reaction products of at least a fuel and combustion air, and contains residual substances, such as particulate matter (dust), sulfur oxides, nitrogen oxides, and carbon monoxide, and, typically, a relatively high content of water.

In one embodiment of the present invention, the exhaust gas to be treated by the method is one or more of the group comprising: cement flue gas, Waste to Energy (WTE) flue gas, lime flue gas, power plant flue gas, refinery flue gas, steel flue gas, blue hydrogen flue gas.

Exhaust gases treatable by the present invention also include chemical production [for example for ammonia, hydrogen, petrochemical], mineral production [for example for cement and lime], natural gas processing, and iron and steel production plants. The present invention is able to separates carbon dioxide (002) emissions from such plant's flue gas or other exhaust stream, that would otherwise have been released to the atmosphere.

Examples of exhaust gases treatable by the present invention also include;

| Flue Gas Source | CO2 concentration |
|---|---|
| Cement off-gas | 20-30% |
| Blast furnace gas | 15-35% |
| Natural gas turbine exhaust | 3-4.5% |
| Coal/oil fired boilers | 3-15% |
| Singas turbine exhaust | 4.5-6.5% |

| Flue Gas Source | CO2 concentration |
|---|---|
| Cement process | 14-33% |
| Steel production (blast furnace) | 20-27% |
| Gas Turbine | 3-4% |
| Lime process | 13-28% |
| Natural Gas Fired Boilers | 8% |
| Fired boiler of oil refinery | 7-10% |
| Hydrogen Production | 15-20% |

| Component | Concentration |
|---|---|
| CO2 | 17.8% |
| H2O | 18.2% |
| O2 | 7.5% |
| N2 | 56.5% |

| Component | Concentration |
|---|---|
| CO2 | 14-33% |
| O2 | 8-14% |

(ref: https:H/doi.org/10.1016/m.egypro.2009.01 0.020)
(ii) a steel manufacturing exhaust gas having a typical composition:

| Component | Concentration |
|---|---|
| CO2 | 21.27% |
| N2 | 55.19% |

(Ref: https://www.sciencedirect.com/science/article/abs/pii/B978178242378200002X)
(iii) a WTE exhaust gas, having a typical comosioition:

| Parameter | |
|---|---|
| CO2 | 5-9% |
| O2 | 8-12% |
| H2O | Saturation |

(ref: https://www.sciencedirect.com/science/article/pii/S1877705812028706)
(iv) a Lime manufacturing exhaust gas having a typical composition:

| Parameter | |
|---|---|
| CO2 | 20.6% |
| O2 | 8.2% |
| N2 | 63.9% |

Ref (https:/lwww.sciencedirect.com/science/article/pii/S1364032122006505)
(v) A Power Plant exhaust gas having a typical composition:

| Flue Gas Source | CO2 concentration |
|---|---|
| Natural Gas Fired Boilers | 14-33% |
| Gas Turbines | 20-27% |
| Coal Fired Boilers | 3-4% |
| Oil Fired Boilers | 8% |
| IGCC | 8-20% |

(ref: https://www.sciencedirect.com/science/article/pii/S1876610209001817?via %3Dihub)
(vi) a Refinery exhaust gas having a typical composition:

| Flue Gas Source | CO2 concentration |
|---|---|
| Gas Fired Process | 3-6% |
| Oil Fired Process | 7-12% |
| FCC Regenerator Stack | 8-12% |

(ref: https://www.concawe.eu/wp-content/uploads/2017/01/rpt 11-7-2011-03321-01-e.pdf)
(vii) a Blue Hydrogen production exhaust gas having a typical composition:

| Flue Gas Source | CO2 concentration |
|---|---|
| Raw H2 | 15% |
| SR Flue Gas | 19% |

(ref: https://www.aidic.it/CISAP4/webpapers/7Collodi.pdf)

In particular, the present invention is able to treat exhaust gases to achieve carbon capture despite such gases having a relatively high water content, for example being ‘humid’ or ‘wet.

Optionally, step (a) of the method of the present invention still absorbs at least 90% of the CO₂ in the exhaust gas.

Optionally, the exhaust gas comprises H₂O in an amount of 0.3-20 v/v %, optionally in the range 0.4-15v/v %, or 0.5-1v/v %, and including ranges based on a lower or upper limit of 0.6 v/v %, 0.7 v/v %, 0.8 v/v %, 0.9 v/v %, 1 v/v %, 1.5 v/v %, 2v/v %, 3v/v %, 4v/v %, 5v/v %, 10v/v % and 15v/v %.

Optionally, the exhaust gas comprises CO₂ in an amount of 3 to 35v/v %, optionally in the range 7 to 35v/v %, more optionally in the range 10 to 25v/v %, and including ranges based on a lower or upper limit of 4 v/v %, 5 v/v %, 6v/v %, 7v/v %, 8v/v %, 10v/v %, 12v/v % and 15v/v % and 20v/v %.

Optionally, the exhaust gas further comprises an oxygen (O2) in an amount of at least 0.1v/v %.

Optionally, the exhaust gas comprises 02 in an amount of 0.1 to 25v/v %, optionally in the range 1 to 15v/v %, more optionally in the range 2 to 12v/v % and including ranges based on a lower or upper limit of 0.6 v/v %, 0.7 v/v %, 0.8 v/v %, 0.9 v/v %, 1 v/v %, 1.5 v/v %, 2v/v %, 3v/v %, 4v/v %, 5v/v %, 10v/v % and 15v/v %.

Optionally, the exhaust gas further comprises nitrogen (N2) in an amount of at least 50v/v %.

Optionally, the exhaust gas comprises N2 in an amount of 50 to 95v/v %, optionally in the range 60 to 90v/v %, more optionally in the range 70 to 80v/v % and including ranges based on a lower or upper limit of 55v/v %, 60 v/v %, 65 v/v %, 70 v/v %, 75v/v %, 80v/v %, 85v/v %, 90v/v %, and 95v/v %.

More particularly, the vacuum in the method is such that the difference in pressure between step (a) and step (b) is 0.1-10 bar, even more particularly 0.6-1.5 bar, and including ranges based on a lower or upper limit of 03 bar, 05 bar, 07 bar, 0.8 bar, 1 bar, 1.5 bar, 2 bar, 3 bar, 5 bar, 7 bar, 8 bar and 10 bar.

Optionally, step (b) provides an outlet stream of at least 85% CO₂. Optionally, step (b) provides an outlet stream of at least 90% or 95% or even at least 97% or 98% CO2. The present invention can provides very high content or pure CO₂ stream as an outlet stream after desorption, for further processing.

Optionally, the method of the present invention further comprising dehydrating the exhaust gas prior to step (a), to the upper limit defined herein.

In particular, the metal organic framework may be in the form of a shaped body. The shaped body can have any suitable form and can be, for example, a pellet, monolith or rod-like extrudate, discs, structured wovens and non-wovens. However, the shape of the body is not particularly limited, and can be tailored for instance to the intended commercial application. In particular, the shaped body may be a pellet. More particularly, the pellet may have a diameter of 0.5-25 mm. In some embodiments, the shaped body may additionally comprise a binder. In the context of the present invention, the term “shaped body” may refer to any solid body comprising the MOF that extends to at least 0.2 mm in at least one direction in space. The body may take any conceivable shape and may extend in any direction by any length so long as it preferably extends to at least 0.2 mm in one direction.

More particularly, the metal organic framework may be formed into a bed. In particular, the metal organic framework may be mixed an additional adsorbent, for example activated carbon and/or zeolites, and formed into a bed. More particularly, the bed may be a fixed bed.

In particular, steps (a) and (b) of the method may be repeated.

In particular, in the method for removing CO₂ and H₂O from an exhaust gas,
the adsorption step may comprise flowing the exhaust gas into contact with the metal organic framework in a first adsorption unit in order to adsorb CO₂ and H₂O onto the metal organic framework,
between steps (a) and (b) there is a step of switching the flow of exhaust gas from the first adsorption unit to a second adsorption unit, and
there is a further adsorption step comprising flowing the exhaust gas into contact with a metal organic framework in the second adsorption unit in order to adsorb CO₂ and H₂O onto the metal organic framework.

It has been surprisingly found by the inventors that switching between adsorbent units (comprising a MOF) after a specific period of time can minimise, or substantially avoid, or completely avoid H₂O-induced deterioration of that MOF.

In particular, the exhaust gas from which the CO₂ and H₂O are removed may comprise gases other than CO₂ and H₂O. More particularly, the gas from which the CO₂ and H₂O are removed may additionally comprise one or more of N₂, O₂, NO, NO₂, SO₂, SO₃ and CH₄. In some embodiments, gases other than CO₂ and H₂O may also be removed.

In particular, the desorption step comprise: applying a vacuum to the first adsorption unit in order to desorb the CO₂ and H₂O adsorbed onto the metal organic framework.

More particularly, the method may comprise, after the desorption step, the step of: switching the flow of gas from the second adsorption unit to either the first adsorption unit or a further adsorption unit.

Another adsorption step can then be carried out which utilises either the first adsorption unit or a further adsorption unit.

In some embodiments, the method may comprise, after the desorption step, the step of switching the flow of gas from the second adsorption unit to the first adsorption unit. For example, this may be the case for methods which only utilise first and second adsorption units.

In other embodiments, the method may comprise, after the desorption step, the step of switching the flow of gas from the second adsorption unit to a further adsorption unit. For example, this may be the case for methods which utilise three or more adsorption units. More particularly, the method may comprise, after the desorption step, the step of switching the flow of gas from the second adsorption unit to a third adsorption unit. For example, this may be the case for methods which only utilise first, second and third adsorption units. Another adsorption step can then be carried out which utilises either the further adsorption unit or the third adsorption unit.

More particularly, the method may comprise, after the step of switching the flow of gas from the second adsorption unit to either the first adsorption unit or a further adsorption unit, the step of: applying a vacuum to the second adsorption unit in order to desorb the adsorbed CO₂ and H₂O.

In a method which only utilises first and second adsorption units, the steps of the method may be repeated as required. In this way, a method for continuous removal of CO₂ and H₂O from a gas may be provided.

In method which only utilises first, second and third adsorption units, the method may comprise, after the step of applying a vacuum to the second adsorption unit in order to desorb the adsorbed CO₂ and H₂O, the step of: switching the flow of gas from the third adsorption unit to the first adsorption unit.

Another adsorption step can then be carried out which utilises the first adsorption unit.

This method may then comprise the step of: applying a vacuum to the third adsorption unit in order to desorb the adsorbed CO₂ and H₂O.

In a method which only utilises first, second and third adsorption units, the steps of the method may be repeated as required. In this way, a method for continuous removal of CO₂ and H₂O from a gas may be provided.

In a method which utilises first, second, third and fourth adsorption units the method may comprise, after the step of applying a vacuum to the second adsorption unit in order to desorb the adsorbed CO₂ and H₂O, the step of switching the flow of gas from the third adsorption unit to either the first adsorption unit or a fourth adsorption unit. Another adsorption step can then be carried out which utilises either the first adsorption unit or the fourth adsorption unit.

This method may then comprise the step of: applying a vacuum to the third adsorption unit in order to desorb the adsorbed CO₂ and H₂O.

This also provides a method for continuous removal of CO₂ and H₂O from a gas.

For methods which utilise more than four adsorption units the method may comprise, after the step of applying a vacuum to the second adsorption unit in order to desorb the adsorbed CO₂ and H₂O, the step of switching the flow of gas from the second adsorption unit to either the first adsorption unit or a further adsorption unit. Another adsorption step can then be carried out which utilises either the first adsorption unit or the further adsorption unit. The method may then comprise the step of switching the flow of gas from the further adsorption unit to the first adsorption unit.

This invention also relates to methods and apparatus which comprise more than four adsorption units (or columns). This includes combinations of adsorption trains comprising multiple columns. In particular, adsorption and desorption may take place in more than one column simultaneously. More particularly, adsorption and desorption may also temporarily overlap within a column.

In particular, the method of the invention may comprise one or more of the following steps: Feed, Trim feed, Adsorption, Pressure equalization, Counter-current blowdown, counter-current purge, Product rinse, Purge step, Light reflux, Heavy reflux, high pressure rinse, Evacuation, Depressurization, Co-current evacuation, Counter-current evacuation, counter current-depressurization, Forward blowdown, Reverse evacuation, Feed plus recycle, Recovery, Recycle, Light purge, Product purge, Light product pressurization, and Repressurization.

For methods which utilise three or more adsorption units, two or more of the adsorption units may simultaneously carry out the same step. For example, the method may comprise one or more of the following (i) two or more of the adsorption units may be carrying out an adsorption step, (ii) two or more of the adsorption units may be carrying out an desorption step, (iii) two or more of the adsorption units may be carrying out any of the steps mentioned in the preceding paragraph.

This invention also relates to an apparatus for removing CO₂ and H₂O from an exhaust gas as defined herein, the apparatus comprising:
(a) an input stream of the exhaust gas which is connectable to either a first or second adsorption unit,
(b)(i) a first adsorption unit comprising a metal organic framework as an adsorbent,
(b)(ii) a second adsorption unit comprising a metal organic framework as an adsorbent, and
(c) a valve through which the input stream of exhaust gas is connectable to either the first or second adsorption unit, the valve being configured such that it switches connection between the first and second adsorption units after 10-900 seconds.

More particularly, the apparatus of the invention may be configured to operate one or more of the following operational steps, Feed, Trim feed, Adsorption, Pressure equalization, Counter-current blowdown, counter-current purge, Product rinse, Purge step, Light reflux, Heavy reflux, high pressure rinse, Evacuation, Depressurization, Co-current evacuation, Counter-current evacuation, counter current-depressurization, Forward blowdown, Reverse evacuation, Feed plus recycle, Recovery, Recycle, Light purge, Product purge, Light product pressurization, and Repressurization.

In particular, the gas from which the CO₂ and H₂O are removed maybe as defined above. More particularly, the metal organic framework may be as defined above.

More particularly, the valve may be configured such that it switches connection between the first and second adsorption units after 20-300 seconds. In particular, the adsorption units may be at a temperature of 5-100° C., more particularly 30-60° C. In particular, the adsorption units may be configured to allow pressure differentials of 0.1-10 bar, more particularly 0.6-1.5 bar.

In some embodiments, the input stream may split into a first adsorption unit input stream which connects to the first adsorption unit, and a second adsorption unit input stream which connects to the second adsorption unit. More particularly, each of the first and second adsorption unit input streams may be provided with a closable valve.

In some embodiments, the apparatus may also comprise:
(d) a first adsorption unit output gas stream, and
(e) a second adsorption unit output gas stream.

In some embodiments, each of the first and second adsorption unit output gas streams may be provided with a closable valve. In particular, between the first and second adsorption units and the valves, the first and second adsorption unit output gas streams may be provided with a fluid connection, for example a pipe, for enabling pressure equalisation between the first and second adsorption units. The fluid connection may be provided with a closable valve.

In some embodiments, the first and second adsorption unit output gas streams may connect to form a single output gas stream. More particularly, the first and second adsorption unit output gas streams may connect to form a single output gas stream on an opposite side of the closable valves from the first and second adsorption units. In particular, the single output gas stream may flow into a buffer unit.

In some embodiments, the first and second adsorption unit input streams may respectively be connected to first and second enriched gas output streams. In particular, the first and second enriched gas output streams may connect to the first and second adsorption unit input streams at a point between each closable valve and the first and second adsorption unit respectively. Alternatively, the first and second enriched gas output streams may respectively be connected to the first and second adsorption units. More particularly, each of the first and second enriched gas output streams may be provided with a closable valve. More particularly, the first and second enriched gas output streams may connect to form a single enriched gas output stream on an opposite side of the closable valves from the first and second adsorption units. In particular, the single enriched gas output stream, or the first and second enriched gas output streams, may connect to a pump for applying a vacuum to the first and second adsorption units via the single enriched gas output stream and either or both of the first and second enriched gas output streams. In this context, the term “enriched gas” is used to refer to the gas which is desorbed from the metal organic framework(s) in the adsorption unit(s), and which is therefore enriched in CO₂ relative to the input stream of gas. More particularly, the pump may be configured to provide a pressure differential of 0.1-10 bar for the desorption of the CO₂ and H₂O from the metal organic framework.

In a further embodiment, the input stream of the gas may be connectable to either a first, second or third adsorption unit, the apparatus may additionally comprise (b)(iii) a third adsorption unit comprising a metal organic framework as an adsorbent, and the valve may be connectable to either the first, second or third adsorption unit.

In particular, the input stream may split into a first adsorption unit input stream which connects to the first adsorption unit, a second adsorption unit input stream which connects to the second adsorption unit, and a third adsorption unit input stream which connects to the third adsorption unit. More particularly, each of the first, second and third adsorption unit input streams may be provided with a closable valve.

In particular, the apparatus may also comprise:
(f) a third adsorption unit output gas stream.

More particularly, each of the first, second and third adsorption unit output gas streams may be provided with a closable valve. In particular, between the first, second and third adsorption units and the valves, the first, second and third adsorption unit output gas streams may be provided with a fluid connection, for example a pipe, for enabling pressure equalisation between the two of the first, second and third adsorption units. The fluid connection may be provided with a closable valve.

In particular, the first, second and third adsorption unit output gas streams may connect to form a single output gas stream. More particularly, the first, second and third adsorption unit output gas streams may connect to form a single output gas stream on an opposite side of the closable valves from the first, second and third adsorption units.

More particularly, the third adsorption unit input streams may be connected to a third enriched gas output stream. In particular, the third enriched gas output stream may connect to the third adsorption unit input stream at a point between the closable valve and the third adsorption unit. Alternatively, the third enriched gas output stream may be connected to the third adsorption unit. More particularly, the third enriched gas output stream may be provided with a closable valve. More particularly, the first, second and third adsorption enriched gas output streams may connect to form a single enriched gas output stream on an opposite side of the closable valves from the first, second and third adsorption units. In particular, the single enriched gas output stream, or the first, second and third enriched gas output streams, may connect to a pump for applying a vacuum to the first, second and third adsorption units via the single enriched gas output stream and either or both of the first, second and third enriched gas output streams.

In a further embodiment, the input stream of the gas may be connectable to either a first, second, third or fourth adsorption unit, the apparatus may additionally comprise (b)(iv) a fourth adsorption unit comprising a metal organic framework as an adsorbent, and the valve may be connectable to either the first, second, third or fourth adsorption unit.

In particular, the input stream may split into a first adsorption unit input stream which connects to the first adsorption unit, a second adsorption unit input stream which connects to the second adsorption unit, a third adsorption unit input stream which connects to the third adsorption unit, and a fourth adsorption unit input stream which connects to the fourth adsorption unit. More particularly, each of the first, second, third and fourth adsorption unit input streams may be provided with a closable valve.

In particular, the apparatus may also comprise:
(f) a fourth adsorption unit output gas stream.

More particularly, each of the first, second, third and fourth adsorption unit output gas streams may be provided with a closable valve. In particular, between the first, second, third and fourth adsorption units and the valves, the first, second, third and fourth adsorption unit output gas streams may be provided with a fluid connection, for example a pipe, for enabling pressure equalisation between the two of the first, second, third and fourth adsorption units. The fluid connection may be provided with a closable valve.

In particular, the first, second, third and fourth adsorption unit output gas streams may connect to form a single output gas stream. More particularly, the first, second, third and fourth adsorption unit output gas streams may connect to form a single output gas stream on an opposite side of the closable valves from the first, second, third and fourth adsorption units.

More particularly, the fourth adsorption unit input streams may be connected to a fourth enriched gas output stream. In particular, the fourth enriched gas output stream may connect to the fourth adsorption unit input stream at a point between the closable valve and the fourth adsorption unit. Alternatively, the fourth enriched gas output stream may be connected to the fourth adsorption unit. More particularly, the fourth enriched gas output stream may be provided with a closable valve. More particularly, the first, second, third and fourth adsorption enriched gas output streams may connect to form a single enriched gas output stream on an opposite side of the closable valves from the first, second, third and fourth adsorption units. In particular, the single enriched gas output stream, or the first, second, third and fourth enriched gas output streams, may connect to a pump for applying a vacuum to the first, second, third and fourth adsorption units via the single enriched gas output stream and either or both of the first, second, third and fourth enriched gas output streams.

### BRIEF DESCRIPTION OF THE DRAWINGS

This invention will be further described by reference to the following Figures which are not intended to limit the scope of the invention claimed, in which:

FIG. 1 shows an apparatus according to the invention for carrying out the method of the invention, the apparatus comprising two adsorption units,

FIG. 2 shows an apparatus according to the invention for carrying out the method of the invention, the apparatus comprising three adsorption units,

FIG. 3 shows an apparatus according to the invention for carrying out the method of the invention, the apparatus comprising four adsorption units,

FIG. 4 shows a graph of CO₂ uptake after 11,829 adsorption/desorption cycles for MOF-74 when utilised according to the method of the invention with an apparatus as shown in FIG. 1, and

FIG. 5 shows a graph of CO₂ uptake after 6,628 adsorption/desorption cycles for MOF-74 when utilised according to the method of the invention with an apparatus as shown in FIG. 2.

FIG. 6 shows a graph of CO₂ uptake after 6,628 adsorption/desorption cycles for MOF-74 when utilised according to the method of the invention with an apparatus as shown in FIG. 3.

### DETAILED DESCRIPTION

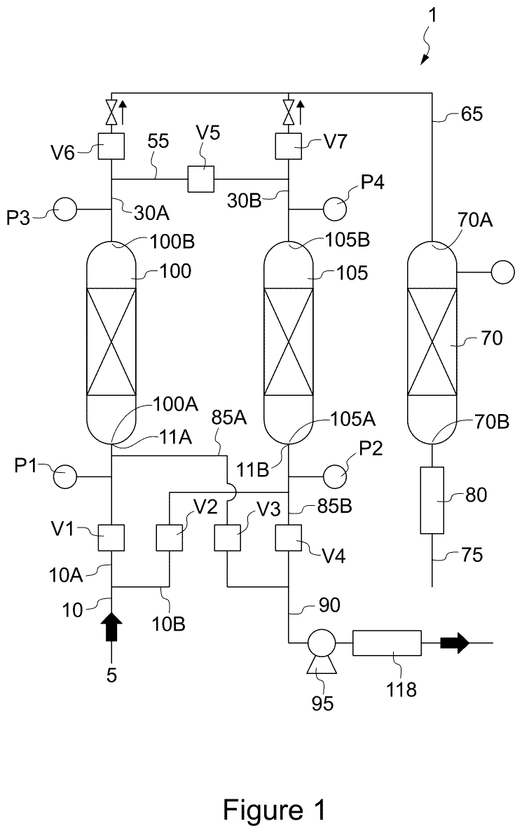

FIG. 1 depicts an apparatus 1 according to the invention. The apparatus 1 is for carrying out the method of the invention.

The apparatus 1 comprises an exhaust gas inlet 5 at the bottom left of FIG. 1. Extending from the gas inlet 5 is column input line 10. Column input line 10 connects the gas inlet 5 to the first and second columns 100, 105 which will be discussed in more detail below.

Between the gas inlet 5 and the first and second columns 100, 105, column input line 10 splits into first column input line 10A which connects to the first column 100, and second column input line 10B which connects to the second column 105. Each of first column input line 10A and second column input line 10B include a valve V1, V2 along their length. The valves V1, V2 can each independently be opened to connect the gas inlet 5 into the respective column 100, 105, or closed to cease connection of the gas inlet 5 into the respective column 100, 105. Between each valve V1, V2 and the respective column 100, 105, first and second column input lines 10A, 10B are each provided with a pressure gauge P1, P2 for monitoring the method.

At their distal ends 11A, 11B, first column input line 10A and second column input line 10B connect to their respective column (also referenced herein as the adsorption units). In the embodiment shown in FIG. 1, the first and second columns 100, 105 are identical. Both columns 100, 105 are in the form of an enclosed chamber within which is provided a bed comprising a MOF. In the embodiment shown in FIG. 1, the MOF is a MOF-74 material with unsaturated metal sites, but other MOFs may be utilised.

Close to the distal ends 11A, 11B of the first and second column input lines 10A, 10B, extend first 85A and second 85B adsorbed gas output lines. Each of first adsorbed gas output line 85A and second adsorbed gas output line 85B include a valve V3, V4 along their length. The valves V3, V4 can each independently be opened to allow flow of adsorbed gas from the respective column 100, 105, or closed to cease flow of adsorbed gas from the respective column 100, 105.

Extending from valves V3, V4, the first and second adsorbed gas output lines 85A, 85B combine to form single adsorbed gas output line 90 which connects to pump 95. The pump 95 can be utilised to provide a vacuum in first and second adsorbed gas output lines 85A, 85B and single adsorbed gas output line 90. Adsorbed gas output line 90 extends further from pump 95 to a flow control and flow indicator device 118, and then to connect to an adsorbed gas collection and/or storage device (not shown).

Each column comprises an input end 100A, 105A to which the first and second column input lines 10A, 10B are connected. Each column also comprises an opposite output end 100B, 105B to which first and second column output lines 30A, 30B are connected. First column output line 30A extends from the first column 100, and second column output line 30B extends from the second column 105.

The MOF is provided within each column 100, 105 between the input 100A, 105A and output 100B, 105B ends such that a gas entering the column 100, 105 from its input end 100A, 105A, flows over the MOF such that CO₂ and H₂O are adsorbed onto the MOF, and exits each column 100, 105 at its output end 100B, 105B and into first and second column output lines 30A, 30B.

Each of first column output line 30A and second column output line 30B include a valve V6, V7 along their length. The valves V6, V7 can each be opened to permit flow of gas from the respective column 100, 105, or closed to cease flow of gas from the respective column 100, 105. Between each valve V6, V7 and the respective column 100, 105, first and second column output lines 30A, 30B are each provided with a pressure gauge P3, P4 for monitoring the method. Between the output ends 100B, 105B of each column, and each valve V6, V7, there is provided column equalisation line 55 which connects first and second column output lines 30A, 30B and which is also provided with a valve V5.

Extending from valves V6, V7, the first and second column output lines 30A, 30B combine to form single output line 65 which connects to input end 70A of buffer tank 70. A further pressure gauge P5 is connected to buffer tank 70. Buffer tank 70 also comprises an output end 70B at an opposite end to input end 70A. Outflow line 75 extends from output end 70B. A flow control and flow indicator device 80 is provided in outflow line 75.

In use, a gas comprising CO₂ and H₂O is caused to flow into the apparatus 1 via gas inlet 5. As noted below, in the Example the gas also contained N₂ and O₂. The method for removing CO₂ and H₂O from the gas then involves the following main stages.

In a first stage, valves V1, V6 and V4 are open whilst valves V2, V3, V5 and V7 are closed. The gas comprising CO₂ and H₂O flows through column input line 10, into first column input line 10A, through valve V1 and into first column 100 at its input end 100A. The gas comprising CO₂ and H₂O flows into contact with the MOF in first column 100 such that CO₂ and H₂O are adsorbed onto the MOF. An output gas having a reduced CO₂ and H₂O content then flows out from first column 100 via its output end 100B. The output gas flows along first column output line 30A, through valve V6, further along first column output line 30A and then into single output line 65. The output gas then flows into buffer tank 70 at its input end 70A, and then out from its output end 70B. The output gas then proceeds to flow through flow control and flow indicator device 80 after which it may be collected and processed as required.

In a second stage, valves V1, V6 and V4 are closed and valve V5 is opened. Thus, valve V5 is the only valve open in this stage. This allows the output gas from first column 100 to flow from output end 100B and along first column output line 30A. The output gas then flows through column equalisation line 55, along second column output line 30B and into the second column 105 at its output end 105B. This step is carried out in order to reduce the pressure differential between the two columns.

In a third stage, valve V5 is closed and valves V2, V3 and V7 are opened. The gas comprising CO₂ and H₂O flows through column input line 10, into second column input line 10B, through valve V2 and into second column 105 at its input end 105A. The gas comprising CO₂ and H₂O flows into contact with the MOF in second column 105 such that CO₂ and H₂O are adsorbed onto the MOF. An output gas having a reduced CO₂ and H₂O content then flows out from second column 105 via its output end 105B. The output gas flows along second column output line 30B, through valve V7, further along second column output line 30B and then into single output line 65. The output gas then flows into buffer tank 70 as described above in relates to the first stage. Whilst this happening, pump 95 is activated such that a vacuum is applied to the first column 100. This vacuum causes the adsorbed CO₂ and H₂O to be desorbed from the MOF in the first column 100. The desorbed CO₂ and H₂O flow from the input end 100A of first column 100, along desorbed gas output line 85A and through valve V3. The desorbed CO₂ and H₂O then continue to flow along single desorbed gas output line 90, through pump 95 and flow control and flow indicator device 100 after which they may be collected and processed as required.

In a fourth stage, valves V2, V3 and V7 are closed and valve V5 is opened. This allows the output gas from second column 105 to flow from output end 105B and along second column output line 30B. The output gas then flows through column equalisation line 55, along first column output line 30A and into the first column 100 at its output end 100B. This step is carried out in order to reduce the pressure differential between the two columns.

In a fifth stage, valve V5 is closed and valves V1, V4 and V6 are opened. As in the first stage, the gas comprising CO₂ and H₂O flows through column input line 10, into first column input line 10A, through valve V1 and into first column 100 at its input end 100A. The gas comprising CO₂ and H₂O flows into contact with the MOF in first column 100 such that CO₂ and H₂O are adsorbed onto the MOF. An output gas having a reduced CO₂ and H₂O content then flows out from first column 100 via its output end 100B. The output gas flows along first column output line 30A, through valve V6, further along first column output line 30A and then into single output line 65. The output gas then flows into buffer tank 70 as described above in relates to the first stage. Whilst this happening, pump 95 is activated such that a vacuum is applied to the second column 105. This vacuum causes the adsorbed CO₂ and H₂O to be desorbed from the MOF in the second column 105. The desorbed CO₂ and H₂O flow from the input end 105A of second column 105, along desorbed gas output line 85B and through valve V4. The desorbed CO₂ and H₂O then continue to flow along single desorbed gas output line 90, through pump 95 and flow control and flow indicator device 100 after which they may be collected and processed as required.

The second to fifth stages can then be repeated as required.

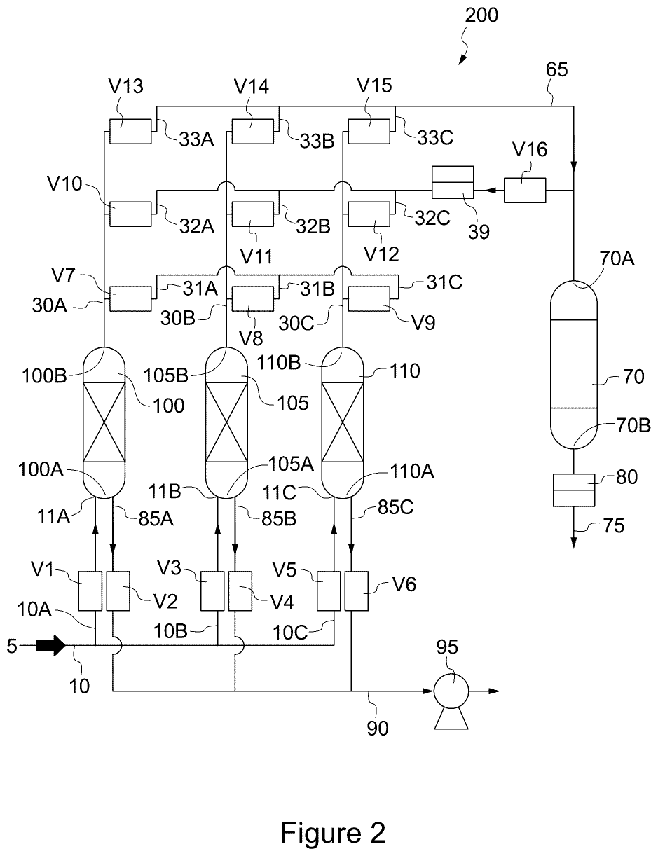

FIG. 2 depicts an apparatus 200 according to the invention. The apparatus 200 is similar to the apparatus 1 of FIG. 1, except that it comprises three adsorption units instead of two. The inclusion of three adsorption units in apparatus 200 also results in additional lines and valves being required. These are described in detail below. Like features with the apparatus 1 of FIG. 1 (except the valves, which are labelled differently) are similarly labelled in FIG. 2.

The apparatus 200 comprises a gas inlet 5 at the bottom left of FIG. 2. Extending from the gas inlet 5 is column input line 10. Column input line 10 connects the gas inlet 5 to the first, second and third columns 100, 105, 110.

Between the gas inlet 5 and the first, second and third columns 100, 105, 110, column input line 10 branches off into first column input line 10A which connects to the first column 100, a second column input line 10B which connects to the second column 105, and a third column input line 10C which connects to the third column 110. Each of first column input line 10A, second column input line 10B and third column input line 10C include a valve V1, V3, V5 along their length. The valves V1, V3, V5 can each independently be opened to connect the gas inlet 5 into the respective column 100, 105, 110, or closed to cease connection of the gas inlet 5 into the respective column 100, 105, 110.

At their distal ends 11A, 11B, 11C, first, second and third column input lines 10A, 10B, 10C connect to their respective column (also referenced herein as the adsorption units). In the embodiment shown in FIG. 2, the first, second and third columns 100, 105, 110 are identical. As in FIG. 1, the columns 100, 105, 110 are in the form of an enclosed chamber within which is provided a bed comprising a MOF. In the embodiment shown in FIG. 2, the MOF is a MOF-74 material with unsaturated metal sites, but other MOFs may be utilised.

Adjacent to the distal ends 11A, 11B, 11C of the first, second and third column input lines 10A, 10B, 10C, first, second and third adsorbed gas output lines 85A, 85B, 85C extend from each column 100, 105, 110. It is noted that, unlike FIG. 1, in FIG. 2 the gas output lines are separate to the column input lines. However, either type of connection can be utilised in the practice of the invention. Each of first, second and third adsorbed gas output lines 85A, 85B, 85C include a valve V2, V4, V6 along its length. The valves V2, V4, V6 can each independently be opened to allow flow of adsorbed gas from the respective column 100, 105, 110, or closed to cease flow of adsorbed gas from the respective column 100, 105, 110.

Extending from valves V2, V4, V6, the first, second and third adsorbed gas output lines 85A, 85B, 85C combine to form single adsorbed gas output line 90 which connects to pump 95. The pump 95 can be utilised to provide a vacuum in first, second and third adsorbed gas output lines 85A, 85B, 85C and single adsorbed gas output line 90. Adsorbed gas output line 90 extends further from pump 95 to an adsorbed gas collection and/or storage device (not shown).

Each column comprises an input end 100A, 105A, 110A to which the first, second and third column input lines 10A, 10B, 10C are connected. Each column also comprises an opposite output end 100B, 105B, 110B to which first, second and third column output lines 30A, 30B, 30C are connected. First column output line 30A extends from the first column 100, second column output line 30B extends from the second column 105, and third column output line 30C extends from the third column 110.

The MOF is provided within each column 100, 105, 110 between the input 100A, 105A, 110A and output 100B, 105B, 110B ends such that a gas entering the column 100, 105, 110 from its input end 100A, 105A, 110A flows over the MOF such that CO₂ and H₂O are adsorbed onto the MOF, and exits each column 100, 105, 110 at its output end 100B, 105B, 110B and into first, second and third column output lines 30A, 30B, 30C.

Each of the first, second and third column output lines 30A, 30B, 30C is directly connected to three valves, each of which can each be opened to permit flow of gas from the respective column 100, 105, 110, or closed to cease flow of gas from the respective column 100, 105, 110. First column output line 30A connects to valves V7, V10 and V13. Second column output line 30B connects to valves V8, V11 and V14. Third column output line 30C connects to valves V9, V12 and V15.

Output line 31A extends from valve V7 and connects to output lines 31B, 31C from valves V8 and V9. Output line 32A extends from valve V10 and connects to output lines 32B, 32C from valves V11 and V12, as well as to flow control and flow indicator device 39 which is connected to further valve V16. Output line 33A extends from valve V13 and connects to output lines 33B, 33C from valves V14 and V15. Output lines 33A, 33B, 33C combine to form single output line 65 which connects to input end 70A of buffer tank 70, as well as to the opposite side of valve V16 from flow control and flow indicator device 39. Buffer tank 70 also comprises an output end 70B at an opposite end to input end 70A. Outflow line 75 extends from output end 70B. A flow control and flow indicator device 80 is provided in outflow line 75.

In use, an exhaust gas comprising CO₂ and H₂O is caused to flow into the apparatus 200 via gas inlet 5. As noted below, in the Example the gas also contained N₂ and O₂. An example method for removing CO₂ and H₂O from the gas using the apparatus 200 of FIG. 2 then involves the following main stages.

In a first stage, valves V1, V8, V9 and V13 are open whilst the other valves are closed. First column 100 is in an adsorption phase in this stage. The gas comprising CO₂ and H₂O flows through column input line 10, into first column input line 10A, through valve V1 and into first column 100 at its input end 100A. The gas comprising CO₂ and H₂O flows into contact with the MOF in first column 100 such that CO₂ and H₂O are adsorbed onto the MOF. An output gas having a reduced CO₂ and H₂O content then flows out from first column 100 via its output end 100B. The output gas flows along first column output line 30A, through valve V13, further along output line 33A and then into single output line 65. The output gas then flows into buffer tank 70 at its input end 70A, and then out from its output end 70B. The output gas then proceeds to flow through flow control and flow indicator device 80 after which it may be collected and processed as required. The opening of valves V8 and V9 allows pressure equalisation between second column 105 and third column 110.

In a second stage, valves V8 and V9 are closed. Valve V6, V11 and V16 are opened and valves V1 and V13 remain open. First column 100 thus remains in an adsorption phase. The opening of valves V11 and V16 means that the output gas flowing along single output line 65 can flow into valve V16, along output line 32B, through second column output line 30B and into second column 105. This results in the pressurisation of second column 105. The opening of valve V6 means that third column 110 is in a blowdown phase. Gas flows from third column 110 along third adsorbed gas output line 85C, through valve V6 and along single desorbed gas output line 90, through pump 95 after which it may be collected and processed as required. Pump 95 is then activated such that this process continues and third column 110 is placed under vacuum.

In a third stage, valves V1, V6, V11, V13 and V16 are closed and valves V3, V7, V9 and V14 are opened. Second column 105 is in an adsorption phase in this stage. The gas comprising CO₂ and H₂O flows through column input line 10, into second column input line 10B, through valve V3 and into second column 105 at its input end 105A. The gas comprising CO₂ and H₂O flows into contact with the MOF in second column 105 such that CO₂ and H₂O are adsorbed onto the MOF. An output gas having a reduced CO₂ and H₂O content then flows out from second column 105 via its output end 105B. The output gas flows along second column output line 30B, through valve V14, further along output line 33B and then into single output line 65. The output gas then flows into buffer tank 70 at its input end 70A, and then out from its output end 70B. The output gas then proceeds to flow through flow control and flow indicator device 80 after which it may be collected and processed as required. The opening of valves V7 and V9 allows pressure equalisation between first column 100 and third column 110.

In a fourth stage, valves V7 and V9 are closed. Valve V2, V12 and V16 are opened and valves V3 and V14 remain open. Second column 105 thus remains in an adsorption phase. The opening of valves V12 and V16 means that the output gas flowing along single output line 65 can flow into valve V16, along output line 32C, through third column output line 30C and into third column 110. This results in the pressurisation of third column 110. The opening of valve V2 means that first column 100 is in a blowdown phase in which the adsorbed CO₂ and H₂O are desorbed from the MOF in first column 100. Gas flows from first column 100 along first adsorbed gas output line 85A, through valve V2 and along single desorbed gas output line 90, through pump 95 after which it may be collected and processed as required. Pump 95 is then activated such that this process continues and first column 100 is placed under vacuum.

In a fifth stage, valves V2, V3, V12, V14 and V16 are closed and valves V5, V7, V8 and V15 are opened. Third column 110 is in an adsorption phase in this stage. The gas comprising CO₂ and H₂O flows through column input line 10, into third column input line 10C, through valve V5 and into third column 110 at its input end 110A. The gas comprising CO₂ and H₂O flows into contact with the MOF in third column 110 such that CO₂ and H₂O are adsorbed onto the MOF. An output gas having a reduced CO₂ and H₂O content then flows out from third column 110 via its output end 110B. The output gas flows along third column output line 30C, through valve V15, further along output line 33C and then into single output line 65. The output gas then flows into buffer tank 70 at its input end 70A, and then out from its output end 70B. The output gas then proceeds to flow through flow control and flow indicator device 80 after which it may be collected and processed as required. The opening of valves V7 and V8 allows pressure equalisation between first column 100 and second column 105.

In a sixth stage, valves V7 and V8 are closed. Valve V4, V10 and V16 are opened and valves V5 and V15 remain open. Third column 110 thus remains in an adsorption phase. The opening of valves V10 and V16 means that the output gas flowing along single output line 65 can flow into valve V16, along output line 32A, through first column output line 30A and into first column 100. This results in the pressurisation of first column 100. The opening of valve V4 means that second column 105 is in a blowdown phase in which the adsorbed CO₂ and H₂O are desorbed from the MOF in second column 105. Gas flows from second column 105 along second adsorbed gas output line 85B, through valve V4 and along single desorbed gas output line 90, through pump 95 after which it may be collected and processed as required. Pump 95 is then activated such that this process continues and second column 105 is placed under vacuum.

The first to sixth stages can then be repeated as required.

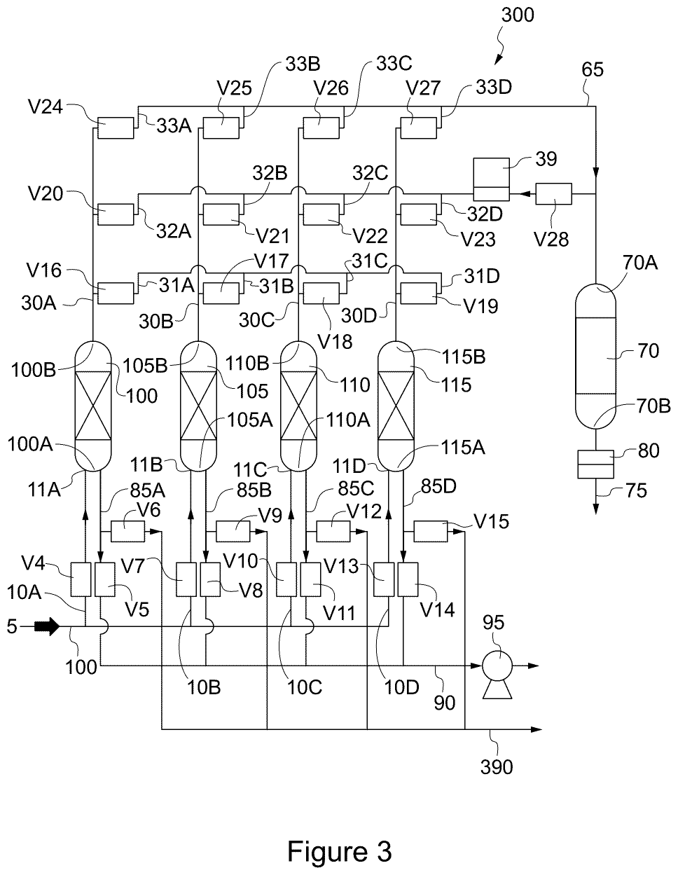

FIG. 3 then depicts an apparatus 300 according to the invention. The apparatus 300 is similar to the apparatus 200 of FIG. 2, except that it comprises four adsorption units instead of three. The inclusion of four adsorption units in apparatus 300 also results in additional lines and valves being required. These are described in detail below. Like features with the apparatus 200 of FIG. 2 (except the valves, which are labelled differently) are similarly labelled in FIG. 3.

The apparatus 300 comprises a gas inlet 5 at the bottom left of FIG. 3. Extending from the gas inlet 5 is column input line 10. Column input line 10 connects the gas inlet 5 to the first, second, third and fourth columns 100, 105, 110, 115. Between the gas inlet 5 and the first, second, third and fourth columns 100, 105, 110, column input line 10 branches off into first column input line 10A which connects to the first column 100, a second column input line 10B which connects to the second column 105, a third column input line 10C which connects to the third column 110, and a fourth column input line 10D which connects to the fourth column 115. Each of first column input line 10A, second column input line 10B, third column input line 10C and fourth column input line 10D include a valve V4, V7, V10, V13 along their length. The valves V4, V7, V10, V13 can each independently be opened to connect the gas inlet 5 into the respective column 100, 105, 110, 115, or closed to cease connection of the gas inlet 5 into the respective column 100, 105, 110, 115.

At their distal ends 11A, 11B, 11C, 11D, first, second, third and fourth column input lines 10A, 10B, 10C, 10D connect to their respective column (also referenced herein as the adsorption units). In the embodiment shown in FIG. 3, the first, second, third and fourth columns 100, 105, 110, 115 are identical. As in FIGS. 1 and 2, the columns 100, 105, 110, 115 are in the form of an enclosed chamber within which is provided a bed comprising a MOF. In the embodiment shown in FIG. 3, the MOF is a MOF-74 material with unsaturated metal sites, but other MOFs may be utilised.

Adjacent to the distal ends 11A, 11B, 11C, 11D of the first, second, third, fourth column input lines 10A, 10B, 10C, 10D, first, second, third and fourth adsorbed gas output lines 85A, 85B, 85C, 85D extend from each column 100, 105, 110, 115. Each of first, second, third and fourth adsorbed gas output lines 85A, 85B, 85C, 85D split into two branches, with a valve V5, V6, V8, V9, V11, V12, V14, V15 provided on each branch. The valves V5, V6, V8, V9, V11, V12, V14, V15 can each independently be opened to allow flow of adsorbed gas from the respective column 100, 105, 110, or closed to cease flow of adsorbed gas from the respective column 100, 105, 110.

Extending from valves V5, V8, V11, V14, the first branches of the first, second, third and fourth adsorbed gas output lines 85A, 85B, 85C, 85D combine to form single adsorbed gas output line 90 which connects to pump 95. The pump 95 can be utilised to provide a vacuum in first, second, third and fourth adsorbed gas output lines 85A, 85B, 85C, 85D and single adsorbed gas output line 90. Adsorbed gas output line 90 extends further from pump 95 to an adsorbed gas collection and/or storage device (not shown).

Extending from valves V6, V9, V12, V15, the second branches of the first, second, third and fourth adsorbed gas output lines 85A, 85B, 85C, 85D combine to form single adsorbed gas output line 390. Adsorbed gas output line 390 extends to an adsorbed gas collection and/or storage device (not shown).

Each column comprises an input end 100A, 105A, 110A, 115A to which the first, second, third and fourth column input lines 10A, 10B, 10C, 10D are connected. Each column also comprises an opposite output end 100B, 105B, 110B, 115B to which first, second, third and fourth column output lines 30A, 30B, 30C, 30D are connected. First column output line 30A extends from the first column 100, second column output line 30B extends from the second column 105, third column output line 30C extends from the third column 110, and fourth column output line 30D extends from the fourth column 115.

The MOF is provided within each column 100, 105, 110, 115 between the input 100A, 105A, 110A, 115A and output 100B, 105B, 110B, 115B ends such that a gas entering the column 100, 105, 110, 115 from its input end 100A, 105A, 110A, 115A flows over the MOF such that CO₂ and H₂O are adsorbed onto the MOF, and exits each column 100, 105, 110, 115 at its output end 100B, 105B, 110B, 115B and into first, second, third and fourth column output lines 30A, 30B, 30C, 30D.

Each of the first, second, third and fourth column output lines 30A, 30B, 30C, 30D is directly connected to three valves, each of which can each be opened to permit flow of gas from the respective column 100, 105, 110, 115, or closed to cease flow of gas from the respective column 100, 105, 110, 115. First column output line 30A connects to valves V16, V20 and V24. Second column output line 30B connects to valves V17, V21 and V25. Third column output line 30C connects to valves V18, V22 and V26. Fourth column output line 30D connects to valves V19, V23 and V27.

Output line 31A extends from valve V16 and connects to output lines 31B, 31C, 31D from valves V17, V18 and V19. Output line 32A extends from valve V20 and connects to output lines 32B, 32C, 32D from valves V21, 22 and V23, as well as to flow control and flow indicator device 39 which is connected to further valve V28.

Output line 33A extends from valve V24 and connects to output lines 33B, 33C, 33D from valves V25, V26 and V27. Output lines 33A, 33B, 33C, 33D combine to form single output line 65 which connects to input end 70A of buffer tank 70, as well as to the opposite side of valve V16 from flow control and flow indicator device 39. Buffer tank 70 also comprises an output end 70B at an opposite end to input end 70A. Outflow line 75 extends from output end 70B. A flow control and flow indicator device 80 is provided in outflow line 75.

Apparatus 300 of FIG. 3 can be utilised in a similar way to apparatus 200 of FIG. 2.

### Example 1

Apparatus for removing CO₂ and H₂O from an exhaust gas was set up as shown in FIG. 1. The MOF utilised was MOF-74.

### Overall Performance Demonstrated:

Performance demonstration over=11829 adsorption/desorption cycles in the
presence of moisture (0.65 v/v %).
Time under humid stream=70976 min.
Total amount of CO₂ removed: 98 kg CO₂.
Performance maintenance: 100%.
Amount of water in contact with the MOF: 2.22 kg H₂O.

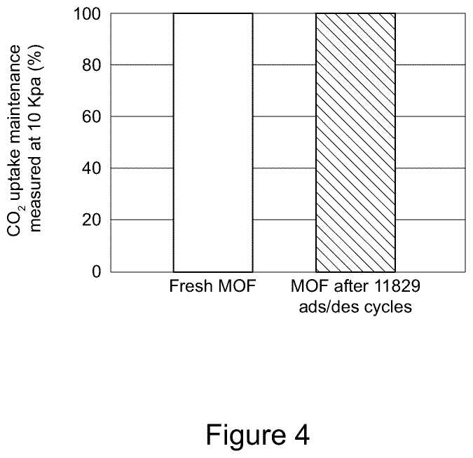

The performance maintenance of 100% is illustrated in FIG. 4. This shows that the CO₂ uptake at 10 kPa of the MOF tested remained unchanged after 11829 adsorption/desorption cycles. This demonstrates how the method and apparatus of the invention provide improved CO₂ adsorption from humid gas streams.

The exhaust gas feed was as follows:

| | | |
|---|---|---|
| CO₂ Feed Concentration | 10.04 | v/v % |
| O₂ Feed Concentration | 2.10 | v/v % |
| N₂ Feed Concentration | 87.21 | v/v % |
| H₂O Feed Concentration | 0.65 | v/v % |
| H₂O Feed Relative Humidity @ 25° C. | 30.00% | RH |

The process parameters were as follows:

| | | |
|---|---|---|
| Bed Temperature | 15-25° | C. |
| Feed Pressure | 1.4 | bar |

The dynamics were as follows:

| | |
|---|---|
| Adsorption Step Time | 3.00 min |
| Desorption Step Time | 3.00 min |

The adsorbent (i.e. MOF-74) characteristics were as follows:

| MOF Pellet Diameter | 2 | mm |
|---|---|---|
| MOF Pellet Length | 2-5 | mm |
| Crush Strength | >5N | |
| Total Mass | 1 | kg |
| Tapped Density | 417 | kg/m³ |

### Example 2

Apparatus for removing CO₂ and H₂O from a gas was set up as shown in FIG. 2. The MOF utilised was MOF-74.

### Overall Performance Demonstrated:

Performance demonstration over=6628 adsorption/desorption cycles in the presence of moisture (0.34 v/v %).
Time under humid stream=120961 min.
Total amount of CO₂ removed: 111.2 kg CO₂.
Performance maintenance: 100%.
Amount of water in contact with the MOF: 1.03 kg H₂O.

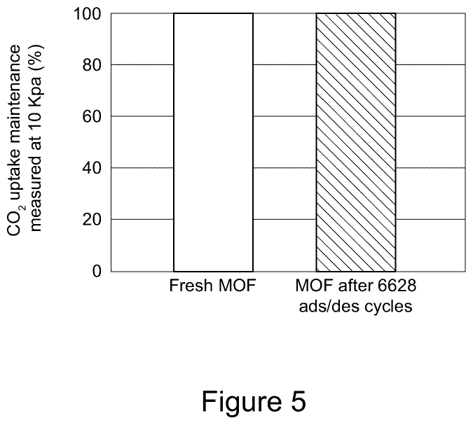

The performance maintenance of 100% is illustrated in FIG. 5. This shows that the CO₂ uptake at 10 kPa of the MOF tested remained unchanged after 6,628 adsorption/desorption cycles. This demonstrates how the method and apparatus of the invention provide improved CO₂ adsorption from humid gas streams.

The feed exhaust as was as follows:

| | | |
|---|---|---|
| CO₂ Feed Concentration | 15.82 | v/v % |
| O₂ Feed Concentration | 4.12 | v/v % |
| N₂ Feed Concentration | 79.72 | v/v % |
| H₂O Feed Concentration | 0.34 | v/v % |
| H₂O Feed Relative Humidity @ 25° C. | 10% | RH |

The process parameters were as follows:

| | | |
|---|---|---|
| Bed Temperature | 21° | C. |
| Feed Pressure | 1.17 | bar |

The dynamics were as follows:

| | |
|---|---|
| Adsorption Step Time | 6 min |
| Desorption Step Time | 12 min |

The adsorbent (i.e. MOF-74) characteristics were as follows:

| MOF Pellet Diameter | 1 | mm |
|---|---|---|
| MOF Pellet Length | 2-4 | mm |
| Crush Strength | >5N | |
| Total Mass | 0.165 | kg |
| Tapped Density | 323.3 | kg/m³ |

The CO2 concentration of the separated CO2 gas stream was 92.7 v/v % (inlet concentration 15.82 v/v % CO2).

### Example 3

Apparatus for removing CO₂ and H₂O from an exhaust gas was set up as shown in FIG. 3. The MOF utilised was MOF-74.

### Overall Performance Demonstrated:

Performance demonstration over=14580 adsorption/desorption cycles in the presence of moisture (0.89 v/v %).
Time under humid stream=243 hours.
Total amount of CO₂ removed: 63.6 kg CO₂.
Performance maintenance: 100%.
Amount of water in contact with the MOF: 1.15 kg H₂O.
Average CO₂ concentration at vacuum outlet: 98%

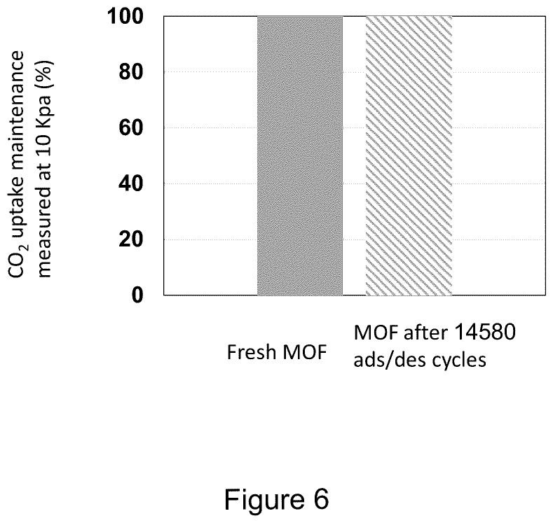

The performance maintenance of 100% is illustrated in FIG. 6. This shows that the CO₂ uptake at 10 kPa of the MOF tested remained unchanged after 14580 adsorption/desorption cycles. This demonstrates how the method and apparatus of the invention provide improved CO₂ adsorption from humid gas streams.

The feed were as follows:

| | | |
|---|---|---|
| CO₂ Feed Concentration | 20.13 | v/v % |
| O₂ Feed Concentration | 12.54 | v/v % |
| N₂ Feed Concentration | 66.44 | v/v % |
| H₂O Feed Concentration | 0.89 | v/v % |
| H₂O Feed Relative Humidity @ 25° C. | 44.94% | RH |

The process parameters were as follows:

| | | |
|---|---|---|
| Bed Temperature | 7-55° | C. |
| Feed Pressure | 1.6 | bar |

The dynamics were as follows:

| | |
|---|---|
| Adsorption Step Time | 30 seconds |
| Desorption Step Time | 30 seconds |

The adsorbent (i.e. MOF-74) characteristics were as follows:

| MOF Pellet Diameter | 1 | mm |
|---|---|---|
| MOF Pellet Length | 2-4 | mm |
| Crush Strength | >5N | |
| Total Mass | 0.123 | kg |
| Tapped Density | 354 | kg/m³ |

The CO2 concentration of the separated CO2 gas stream was 98.0 v/v % (inlet concentration 20.13v/v %).

The present invention can remove CO2 molecules from high water-content industrial exhaust and flue gas streams (prior to being emitted to the atmosphere). The separated CO2 gas stream produced by the present invention is of sufficient purity to enable its utilisation, compression or storage underground. Thus, the present invention helps meet targets of producing a separated CO2 stream with CO2 purity above 85%, (more specifically above 90% or even above 95%). The present invention can therefore provide mitigation of carbon dioxide (CO2) emissions from large point sources such as power plants, refineries and other industrial facilities (including cement production, steel production, waste to energy, lime production, or blue hydrogen production).

1. A method for removing CO₂ and H₂O from an exhaust gas, the method comprising:
(a) an adsorption step in which a non-amine metal organic framework is contacted for 10-900 seconds with an exhaust gas comprising CO₂ in an amount of at least 3 v/v %, and H₂O in an amount of at least 0.3 v/v %, in order to adsorb CO₂ and H₂O onto the metal organic framework, and
(b) a desorption step in which a vacuum is applied to the metal organic framework from step (a) such that CO₂ and H₂O are desorbed from the metal organic framework.

2. A method as claimed in claim 1, wherein in step (a) the metal organic framework is contacted for 10-300 seconds with the exhaust gas, optionally for 15-200 seconds, more optionally for 20-60 seconds.

3. A method as claimed in claim 1, wherein in step (b), the vacuum is applied to the metal organic framework for 10-300 seconds, optionally for 15-200 seconds, more optionally for 20-60 seconds.

4. A method as claimed in claim 1, wherein the metal organic framework comprises an organic ligand, the organic ligand optionally comprising a dicarboxylate ligand, a tricarboxylate ligand, or a tetracarboxylate ligand.

5. A method as claimed in claim 1, wherein the metal organic framework comprises metal cations with a valency of 2 or more, and optionally the metal cations comprise Mg²⁺, Ca2+, Mn²⁺, Fe²⁺, Co²⁺, Cu²⁺, Ni²⁺ or Zn²⁺.

6. A method as claimed in claim 1, wherein the organic ligand comprises a benzene dicarboxylate ligand or a benzene tricarboxylate ligand.

7. A method as claimed in claim 6, wherein the organic ligand comprises 2,5-dioxido-1,4-benzenedicarboxylate or 1,3,5-benzenetricarboxylate.

8. A method as claimed in claim 1, wherein step (a) is carried out at a temperature of 5-100° C.

9. A method as claimed in claim 8, wherein step (a) is carried out at a temperature of 30-60° C.

10. A method as claimed in claim 1, wherein the exhaust gas comprises H₂O in an amount of 0.3-20 v/v %, optionally in the range 0.4-15v/v %, more optionally in the range 0.5-1v/v %.

11. A method as claimed in claim 1, wherein the exhaust gas comprises CO2 in an amount of 3 to 35v/v %, optionally in the range 7 to 35v/v %, more optionally in the range 10 to 25v/v %.

12. (canceled)

13. A method as claimed in claim 1, wherein the exhaust gas comprises O2 in an amount of 0.1 to 25v/v %, optionally in the range 1 to 15v/v %, more optionally in the range 2 to 12v/v %.

14. (canceled)

15. A method as claimed in claim 1, wherein the exhaust gas comprises N2 in an amount of 50 to 95v/v %, optionally in the range 60 to 90v/v %, more optionally in the range 70 to 80v/v %.

16. A method as claimed in claim 1, wherein the exhaust gas is one or more of the group comprising: cement flue gas, Waste to Energy (WTE) flue gas, lime flue gas, power plant flue gas, refinery flue gas, steel flue gas, blue hydrogen flue gas.

17. A method as claimed in claim 1, wherein step (a) absorbs at least 90% of the CO2 in the exhaust gas.

18. A method as claimed in claim 1, wherein the vacuum is such that the difference in pressure between step (a) and step (b) is 0.1-10 bar.

19. A method as claimed in claim 18, wherein the vacuum is such that the difference in pressure between step (a) and step (b) is 0.6-1.5 bar.

20. A method as claimed in claim 1, wherein step (b) provides an outlet stream of at least 85% CO2.

21. A method as claimed in claim 1, further comprising dehydrating the exhaust gas prior to step (a).

22. An apparatus for removing CO₂ and H₂O from an exhaust gas as defined in claim 1, the apparatus comprising:
(a) an input stream of the exhaust gas which is connectable to either a first or second adsorption unit,
(b)(i) a first adsorption unit comprising a non-amine metal organic framework as an adsorbent,
(b)(ii) a second adsorption unit comprising a non-amine metal organic framework as an adsorbent, and
(c) a valve through which the input stream of exhaust gas is connectable to either the first or second adsorption unit, the valve being configured such that it switches connection between the first and second adsorption units after 10-900 seconds.

23. (canceled)

24. (canceled)

25. (canceled)

26. (canceled)

27. (canceled)

28. (canceled)

29. (canceled)
